(19) United States
(12) Patent Application Publication
(10) Pub. No.: US 2026/0196018 A1
(43) Pub. Date: Jul. 9, 2026

(54) SENSOR FUSION METHOD AND PARKING CONTROL DEVICE USING THE SAME

(71) Applicant: HYUNDAI MOBIS CO., LTD., Seoul (KR)

(72) Inventor: Dong Yun SON, Yongin-si (KR)

(73) Assignee: HYUNDAI MOBIS CO., LTD., Seoul (KR)

(21) Appl. No.: 19/361,436

(22) Filed: Oct. 17, 2025

(30) Foreign Application Priority Data
Jan. 8, 2025 (KR) 10-2025-0002869

(51) Int. Cl. G06V 10/762; G01S 15/08; G01S 15/931; G06V 20/58

(52) U.S. Cl. CPC G06V 10/762; G01S 15/08; G01S 15/931; G06V 20/586; G01S 2015/932

(57) ABSTRACT

A parking control device for a vehicle, a method thereof and a system thereof are provided. The parking control device includes: a space detection pre-processor to acquire space detection result values from an image acquired by a camera sensor; an ultrasonic signal pre-processor to acquire a distance value corresponding to an ultrasonic signal received by an ultrasonic sensor; and a processor to compare the space detection result values with the distance value corresponding to the ultrasonic signal and determine space detection result values having the same distance value among the space detection result values as valid space detection result values, cluster the space detection result values except for the valid space detection result values, and include the clustered space detection result values into the valid space detection result values.

### CROSS-REFERENCE TO RELATED APPLICATIONS

Pursuant to 35 U.S.C. § 119(a), this application claims the benefit of earlier filing dates and right of priority to Korean Application No. 10-2025-0002869, filed on January 8, 2025, in the Korean Intellectual Property Office, the contents of which are hereby incorporated by reference herein in their entirety for all purposes.

### BACKGROUND

### 1. Field of the Disclosure

The present embodiments are applicable to autonomous vehicles in all fields, and more specifically, may be applied to vehicle systems that include, for example, ultrasonic sensors and camera sensors.

### 2. Description of the Related Art

Ultrasonic sensors mounted on the front or rear bumpers of a vehicle, or on other parts of the vehicle body, are important components of a parking assistance system or rear parking sensors. The ultrasonic sensors help prevent collisions by detecting obstacles at the rear or the sides of the vehicle when the driver is parking.

An ultrasonic sensor periodically emits high-frequency sound waves (ultrasound), and when these transmitted ultrasonic signals hit an obstacle, receives reflected signals. Through this process, the Time of Flight (ToF) value, hereinafter referred to as ultrasonic sensor data, may be obtained by the ultrasonic sensor and used to estimate the location of an obstacle.

Conventional ultrasonic sensors are capable of detecting both low-height obstacles (such as gravel, stoppers, or low curbs) and high-height obstacles (such as parking pillars or objects tall enough to damage the vehicle).

Conventional parking assistance systems have difficulty identifying the shape of an object using only ultrasonic sensors. Therefore, they use sensor fusion of ultrasonic sensor data and camera data to detect obstacles.

However, such conventional parking assistance systems rely on space detection information from the camera only at long distances and may fail to recognize targets to be controlled at short distances, which may result in unintended braking.

### SUMMARY

An embodiment of the present disclosure is directed to providing a parking control device that fuses sensor data from an ultrasonic sensor and a camera.

The objects to be achieved by the present disclosure are not limited to those mentioned above, and other technical objects not explicitly stated will become readily apparent to those skilled in the art from the detailed description provided below.

In a general aspect, a parking control device for a vehicle includes: a space detection pre-processor configured to acquire space detection result values from an image acquired by a camera sensor; an ultrasonic signal pre-processor configured to acquire a distance value corresponding to an ultrasonic signal received by an ultrasonic sensor; and a processor configured to compare the space detection result values with the distance value corresponding to the ultrasonic signal and determine space detection result values having the same distance value among the space detection result values as valid space detection result values, cluster the space detection result values except for the valid space detection result values, and include the clustered space detection result values into the valid space detection result values.

The space detection pre-processor may be further configured to: accumulate the space detection result values in a time series to determine a class with a maximum accumulation of the space detection result values as a representative class; and determine whether the representative class is a first class composed of objects having a height unlikely to cause damage to the vehicle.

The processor may be further configured to determine whether a target detected by the ultrasonic sensor and the space detection result value included in the first class represent the same target based on the representative class being the first class.

The processor may be further configured to delete coordinates of the space detection result value corresponding to the same target based on the target detected by the ultrasonic sensor and the space detection result value included in the first class representing the same target.

The clustered space detection result values may be space detection result values unmatched to the distance value corresponding to the ultrasonic signal.

The processor may be further configured to match the space detection result value corresponding to the second class with the distance value corresponding to the object detected by the ultrasonic sensor based on the representative class being a second class composed of objects having a height likely to cause damage to the vehicle.

The processor may be further configured to determine the space detection result value as one of the valid space detection result values based on a frequency of matching between the space detection result value corresponding to the second class and the distance value corresponding to the object detected by the ultrasonic sensor being greater than or equal to a threshold.

In another general aspect, a sensor fusion method for a vehicle, includes: acquiring space detection result values from an image acquired by a camera sensor; acquiring a distance value corresponding to an ultrasonic signal received by an ultrasonic sensor; comparing the space detection result values with the distance value corresponding to the ultrasonic signal and determining space detection result values having the same distance value among the space detection result values as valid space detection result values; clustering the space detection result values except for the valid space detection result values; and including the clustered space detection result values into the valid space detection result values.

The acquiring of the space detection result values may include: accumulating the space detection result values in a time series to determine a class with a maximum accumulation of the space detection result values as a representative class; and determining whether the representative class is a first class composed of objects having a height unlikely to cause damage to the vehicle.

The method may further include: determining whether a target detected by the ultrasonic sensor and the space detection result value included in the first class represent the same target based on the representative class being the first class; and deleting coordinates of the space detection result value corresponding to the same target based on the target detected by the ultrasonic sensor and the space detection result value included in the first class representing the same target.

In yet another general aspect, a parking control system for a vehicle, includes: a camera sensor; a space detection pre-processor configured to acquire space detection result values from an image acquired by the camera sensor; an ultrasonic sensor; an ultrasonic signal pre-processor configured to acquire a distance value corresponding to an ultrasonic signal received by the ultrasonic sensor; and a processor configured to compare the space detection result values with the distance value corresponding to the ultrasonic signal and determine space detection result values having the same distance value among the space detection result values as valid space detection result values, cluster the space detection result values except for the valid space detection result values, and include the clustered space detection result values into the valid space detection result values.

The space detection pre-processor may be further configured to: accumulate the space detection result values in a time series to determine a class with a maximum accumulation of the space detection result values as a representative class; and determine whether the representative class is a first class composed of objects having a height unlikely to cause damage to the vehicle.

The processor may be further configured to determine whether a target detected by the ultrasonic sensor and the space detection result value included in the first class represent the same target based on the representative class being the first class.

The processor may be further configured to delete coordinates of the space detection result value corresponding to the same target based on the target detected by the ultrasonic sensor and the space detection result value included in the first class representing the same target.

The clustered space detection result values may be space detection result values unmatched to the distance value corresponding to the ultrasonic signal.

According to an embodiment, the detection range of the ultrasonic sensor may be extended by identifying and filtering out low-height objects based on the result of space detection.

According to an embodiment, the shape of an object may be identified based on the result of space detection, thereby enabling control of the driving path.

The effects obtainable from the present disclosure are not limited to those mentioned above, and other effects not mentioned above will be readily understood by those skilled in the art based on the following detailed description.

### BRIEF DESCRIPTION OF THE DRAWINGS

FIG. 1 is an overall block diagram of an autonomous driving control system to which an autonomous driving device according to one embodiment of the present disclosure is applicable;

FIG. 2 is an exemplary diagram illustrating an example in which the autonomous driving device according to one embodiment of the present disclosure is applied to an autonomous vehicle;

FIG. 3 is a block diagram illustrating a parking control device according to one embodiment of the present disclosure;

FIG. 4 is a diagram illustrating a method of recognizing space detection classes according to one embodiment of the present disclosure.

FIG. 5 is a diagram illustrating a method of matching space detection nodes and ultrasonic sensor-based distance values according to one embodiment of the present disclosure;

FIG. 6 is a diagram illustrating a method of filtering by matching space detection nodes and ultrasonic sensor-based distance values according to one embodiment of the present disclosure;

FIG. 7 is a diagram illustrating a process of clustering space detection nodes according to one embodiment of the present disclosure;

FIGS. 8 and 9 are diagrams illustrating results of sensor fusion based on space detection according to one embodiment of the present disclosure; and

FIGS. 10 and 11 are flowcharts illustrating a sensor fusion method in a parking space according to one embodiment of the present disclosure.

### DETAILED DESCRIPTION

Hereinafter, with reference to the accompanying drawings, embodiments of the present disclosure will be described in detail so that those skilled in the art can easily practice the present disclosure. However, the present disclosure may be implemented in various different forms and is not limited to the embodiments described herein. In addition, in the drawings, in order to clearly explain the present disclosure, parts that are not related to the description will be omitted, and the same or similar parts are denoted by the same reference numerals throughout the description.

Throughout the description, when a part is referred to as “including” an element, it may not mean that the part excludes other elements, but may mean that the part includes other elements, unless stated otherwise.

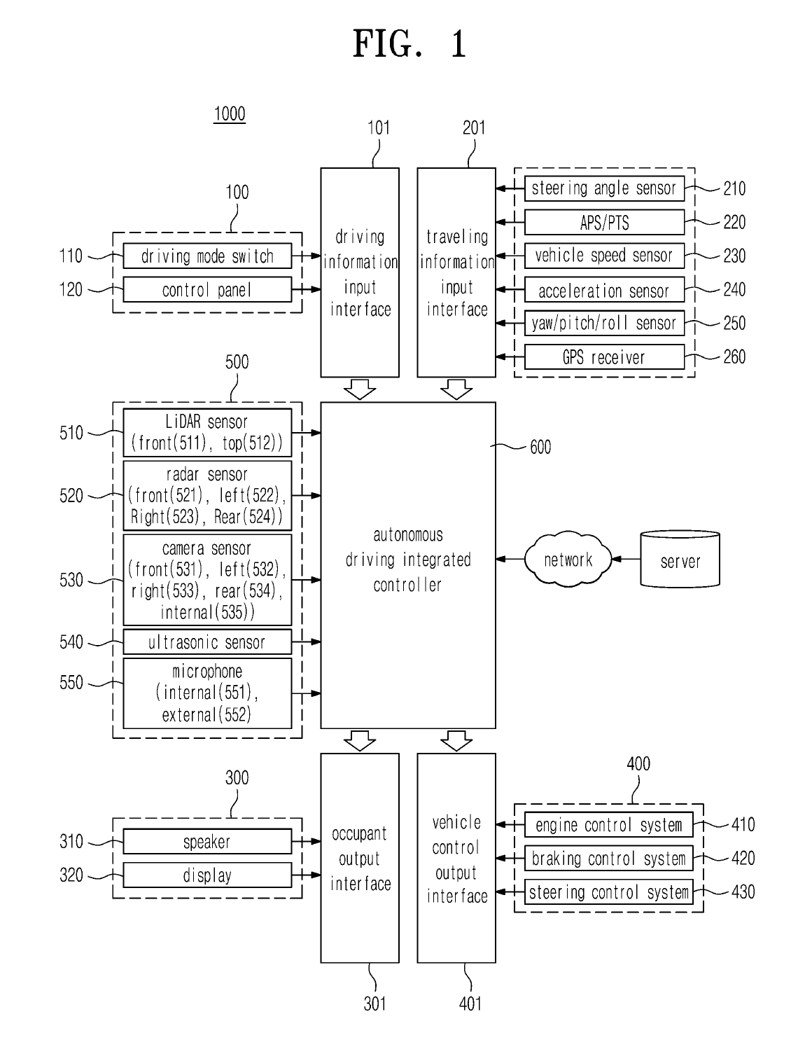

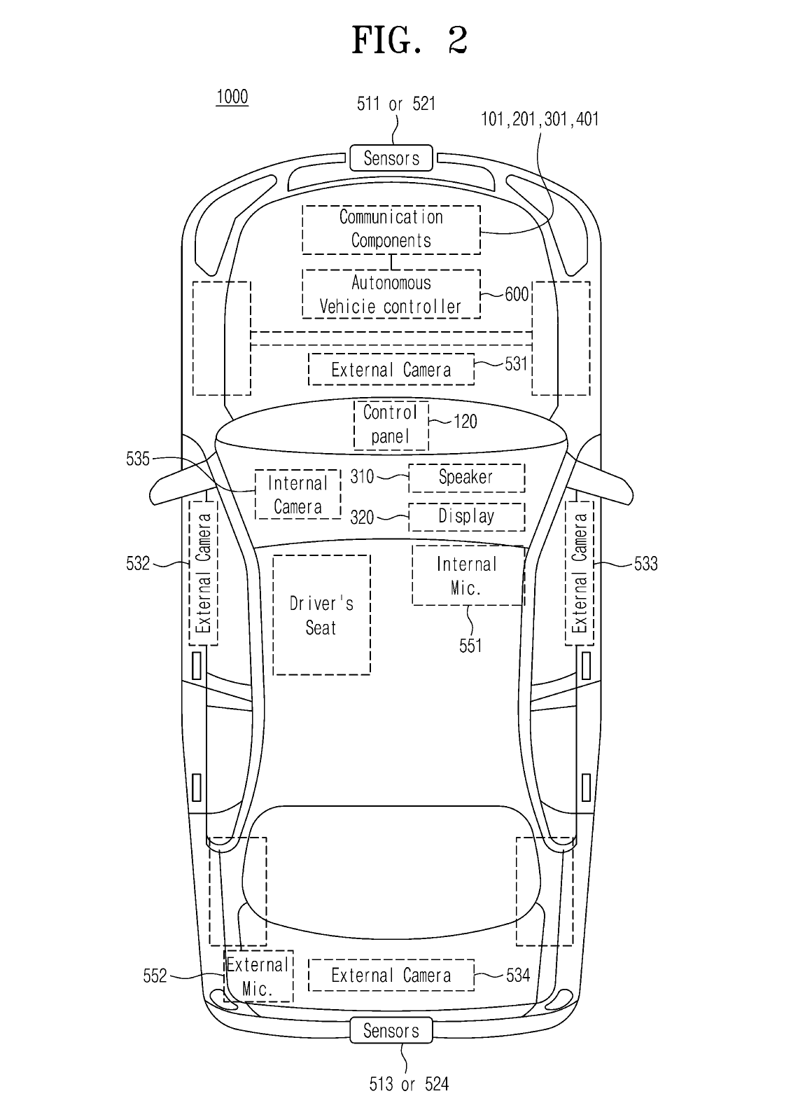

FIG. 1 is an overall block diagram of an autonomous driving control system to which an autonomous driving apparatus according to any one of embodiments of the present disclosure is applicable. FIG. 2 is a diagram illustrating an example in which an autonomous driving apparatus according to any one of embodiments of the present disclosure is applied to a vehicle.

First, a structure and function of an autonomous driving control system (e.g., an autonomous driving vehicle) to which an autonomous driving apparatus according to the present embodiments is applicable will be described with reference to FIGS. 1 and 2.

As illustrated in FIG. 1, an autonomous driving vehicle 1000 may be implemented based on an autonomous driving integrated controller 600 that transmits and receives data necessary for autonomous driving control of a vehicle through a driving information input interface 101, a traveling information input interface 201, an occupant output interface 301, and a vehicle control output interface 401. However, the autonomous driving integrated controller 600 may also be referred to herein as a controller, a processor, or, simply, a controller.

The autonomous driving integrated controller 600 may obtain, through the driving information input interface 101, driving information based on manipulation of an occupant for a user input unit 100 in an autonomous driving mode or manual driving mode of a vehicle. As illustrated in FIG. 1, the user input unit 100 may include a driving mode switch 110 and a control panel 120 (e.g., a navigation terminal mounted on the vehicle or a smartphone or tablet computer owned by the occupant). Accordingly, driving information may include driving mode information and navigation information of a vehicle.

For example, a driving mode (i.e., an autonomous driving mode/manual driving mode or a sports mode/eco mode/safety mode/normal mode) of the vehicle determined by manipulation of the occupant for the driving mode switch 110 may be transmitted to the autonomous driving integrated controller 600 through the driving information input interface 101 as the driving information.

Furthermore, navigation information, such as the destination of the occupant input through the control panel 120 and a path up to the destination (e.g., the shortest path or preference path, selected by the occupant, among candidate paths up to the destination), may be transmitted to the autonomous driving integrated controller 600 through the driving information input interface 101 as the driving information.

The control panel 120 may be implemented as a touchscreen panel that provides a user interface (UI) through which the occupant inputs or modifies information for autonomous driving control of the vehicle. In this case, the driving mode switch 110 may be implemented as touch buttons on the control panel 120.

In addition, the autonomous driving integrated controller 600 may obtain traveling information indicative of a driving state of the vehicle through the traveling information input interface 201. The traveling information may include a steering angle formed when the occupant manipulates a steering wheel, an accelerator pedal stroke or brake pedal stroke formed when the occupant depresses an accelerator pedal or brake pedal, and various types of information indicative of driving states and behaviors of the vehicle, such as a vehicle speed, acceleration, a yaw, a pitch, and a roll formed in the vehicle. The traveling information may be detected by a traveling information detection unit 200, including a steering angle sensor 210, an accelerator position sensor (APS)/pedal travel sensor (PTS) 220, a vehicle speed sensor 230, an acceleration sensor 240, and a yaw/pitch/roll sensor 250, as illustrated in FIG. 1.

Furthermore, the traveling information of the vehicle may include location information of the vehicle. The location information of the vehicle may be obtained through a global positioning system (GPS) receiver 260 applied to the vehicle. Such traveling information may be transmitted to the autonomous driving integrated controller 600 through the traveling information input interface 201 and may be used to control the driving of the vehicle in the autonomous driving mode or manual driving mode of the vehicle.

The autonomous driving integrated controller 600 may transmit driving state information provided to the occupant to an output unit 300 through the occupant output interface 301 in the autonomous driving mode or manual driving mode of the vehicle. That is, the autonomous driving integrated controller 600 transmits the driving state information of the vehicle to the output unit 300 so that the occupant may check the autonomous driving state or manual driving state of the vehicle based on the driving state information output through the output unit 300. The driving state information may include various types of information indicative of driving states of the vehicle, such as a current driving mode, transmission range, and speed of the vehicle.

If it is determined that it is necessary to warn a driver in the autonomous driving mode or manual driving mode of the vehicle along with the above driving state information, the autonomous driving integrated controller 600 transmits warning information to the output unit 300 through the occupant output interface 301 so that the output unit 300 may output a warning to the driver. In order to output such driving state information and warning information acoustically and visually, the output unit 300 may include a speaker 310 and a display 320 as illustrated in FIG. 1. In this case, the display 320 may be implemented as the same device as the control panel 120 or may be implemented as an independent device separated from the control panel 120.

Furthermore, the autonomous driving integrated controller 600 may transmit control information for driving control of the vehicle to a lower control system 400, applied to the vehicle, through the vehicle control output interface 401 in the autonomous driving mode or manual driving mode of the vehicle. As illustrated in FIG. 1, the lower control system 400 for driving control of the vehicle may include an engine control system 410, a braking control system 420, and a steering control system 430. The autonomous driving integrated controller 600 may transmit engine control information, braking control information, and steering control information, as the control information, to the respective lower control systems 410, 420, and 430 through the vehicle control output interface 401. Accordingly, the engine control system 410 may control the speed and acceleration of the vehicle by increasing or decreasing fuel supplied to an engine. The braking control system 420 may control the braking of the vehicle by controlling braking power of the vehicle. The steering control system 430 may control the steering of the vehicle through a steering device (e.g., motor driven power steering (MDPS) system) applied to the vehicle.

As described above, the autonomous driving integrated controller 600 according to the present embodiment may obtain the driving information based on manipulation of the driver and the traveling information indicative of the driving state of the vehicle through the driving information input interface 101 and the traveling information input interface 201, respectively, and transmit the driving state information and the warning information, generated based on an autonomous driving algorithm, to the output unit 300 through the occupant output interface 301. In addition, the autonomous driving integrated controller 600 may transmit the control information generated based on the autonomous driving algorithm to the lower control system 400 through the vehicle control output interface 401 so that driving control of the vehicle is performed.

In order to guarantee stable autonomous driving of the vehicle, it is necessary to continuously monitor the driving state of the vehicle by accurately measuring a driving environment of the vehicle and to control driving based on the measured driving environment. To this end, as illustrated in FIG. 1, the autonomous driving apparatus according to the present embodiment may include a sensor unit 500 for detecting a nearby object of the vehicle, such as a nearby vehicle, pedestrian, road, or fixed facility (e.g., a signal light, a signpost, a traffic sign, or a construction fence).

The sensor unit 500 may include one or more of a LiDAR sensor 510, a radar sensor 520, or a camera sensor 530, in order to detect a nearby object outside the vehicle, as illustrated in FIG. 1.

The LiDAR sensor 510 may transmit a laser signal to the periphery of the vehicle and detect a nearby object outside the vehicle by receiving a signal reflected and returning from a corresponding object. The LiDAR sensor 510 may detect a nearby object located within the ranges of a preset distance, a preset vertical field of view, and a preset horizontal field of view, which are predefined depending on specifications thereof. The LiDAR sensor 510 may include a front LiDAR sensor 511, a top LiDAR sensor 512, and a rear LiDAR sensor 513 installed at the front, top, and rear of the vehicle, respectively, but the installation location of each LiDAR sensor and the number of LiDAR sensors installed are not limited to a specific embodiment. A threshold for determining the validity of a laser signal reflected and returning from a corresponding object may be previously stored in a memory (not illustrated) of the autonomous driving integrated controller 600. The autonomous driving integrated controller 600 may determine a location (including a distance to a corresponding object), speed, and moving direction of the corresponding object using a method of measuring time taken for a laser signal, transmitted through the LiDAR sensor 510, to be reflected and returning from the corresponding object.

The radar sensor 520 may radiate electromagnetic waves around the vehicle and detect a nearby object outside the vehicle by receiving a signal reflected and returning from a corresponding object. The radar sensor 520 may detect a nearby object within the ranges of a preset distance, a preset vertical field of view, and a preset horizontal field of view, which are predefined depending on specifications thereof. The radar sensor 520 may include a front radar sensor 521, a left radar sensor 522, a right radar sensor 523, and a rear radar sensor 524 installed at the front, left, right, and rear of the vehicle, respectively, but the installation location of each radar sensor and the number of radar sensors installed are not limited to a specific embodiment. The autonomous driving integrated controller 600 may determine a location (including a distance to a corresponding object), speed, and moving direction of the corresponding object using a method of analyzing power of electromagnetic waves transmitted and received through the radar sensor 520.

The camera sensor 530 may detect a nearby object outside the vehicle by photographing the periphery of the vehicle and detect a nearby object within the ranges of a preset distance, a preset vertical field of view, and a preset horizontal field of view, which are predefined depending on specifications thereof.

The camera sensor 530 may include a front camera sensor 531, a left camera sensor 532, a right camera sensor 533, and a rear camera sensor 534 installed at the front, left, right, and rear of the vehicle, respectively, but the installation location of each camera sensor and the number of camera sensors installed are not limited to a specific embodiment. The autonomous driving integrated controller 600 may determine a location (including a distance to a corresponding object), speed, and moving direction of the corresponding object by applying predefined image processing to an image captured by the camera sensor 530.

In addition, an internal camera sensor 535 for capturing the inside of the vehicle may be mounted at a predetermined location (e.g., rear view mirror) within the vehicle. The autonomous driving integrated controller 600 may monitor a behavior and state of the occupant based on an image captured by the internal camera sensor 535 and output guidance or a warning to the occupant through the output unit 300.

As illustrated in FIG. 1, the sensor unit 500 may further include an ultrasonic sensor 540 in addition to the LiDAR sensor 510, the radar sensor 520, and the camera sensor 530 and further adopt various types of sensors for detecting a nearby object of the vehicle along with the sensors.

FIG. 2 illustrates an example in which, in order to aid in understanding the present embodiment, the front LiDAR sensor 511 or the front radar sensor 521 is installed at the front of the vehicle, the rear LiDAR sensor 513 or the rear radar sensor 524 is installed at the rear of the vehicle, and the front camera sensor 531, the left camera sensor 532, the right camera sensor 533, and the rear camera sensor 534 are installed at the front, left, right, and rear of the vehicle, respectively. However, as described above, the installation location of each sensor and the number of sensors installed are not limited to a specific embodiment.

Furthermore, in order to determine a state of the occupant within the vehicle, the sensor unit 500 may further include a bio sensor for detecting bio signals (e.g., heart rate, electrocardiogram, respiration, blood pressure, body temperature, electroencephalogram, photoplethysmography (or pulse wave), and blood sugar) of the occupant. The bio sensor may include a heart rate sensor, an electrocardiogram sensor, a respiration sensor, a blood pressure sensor, a body temperature sensor, an electroencephalogram sensor, a photoplethysmography sensor, and a blood sugar sensor.

Finally, the sensor unit 500 additionally includes a microphone 550 having an internal microphone 551 and an external microphone 552 used for different purposes.

The internal microphone 551 may be used, for example, to analyze the voice of the occupant in the autonomous driving vehicle 1000 based on AI or to immediately respond to a direct voice command of the occupant.

In contrast, the external microphone 552 may be used, for example, to appropriately respond to safe driving by analyzing various sounds generated from the outside of the autonomous driving vehicle 1000 using various analysis tools such as deep learning.

For reference, the symbols illustrated in FIG. 2 may perform the same or similar functions as those illustrated in FIG. 1. FIG. 2 illustrates in more detail a relative positional relationship of each component (based on the interior of the autonomous driving vehicle 1000) as compared with FIG. 1.

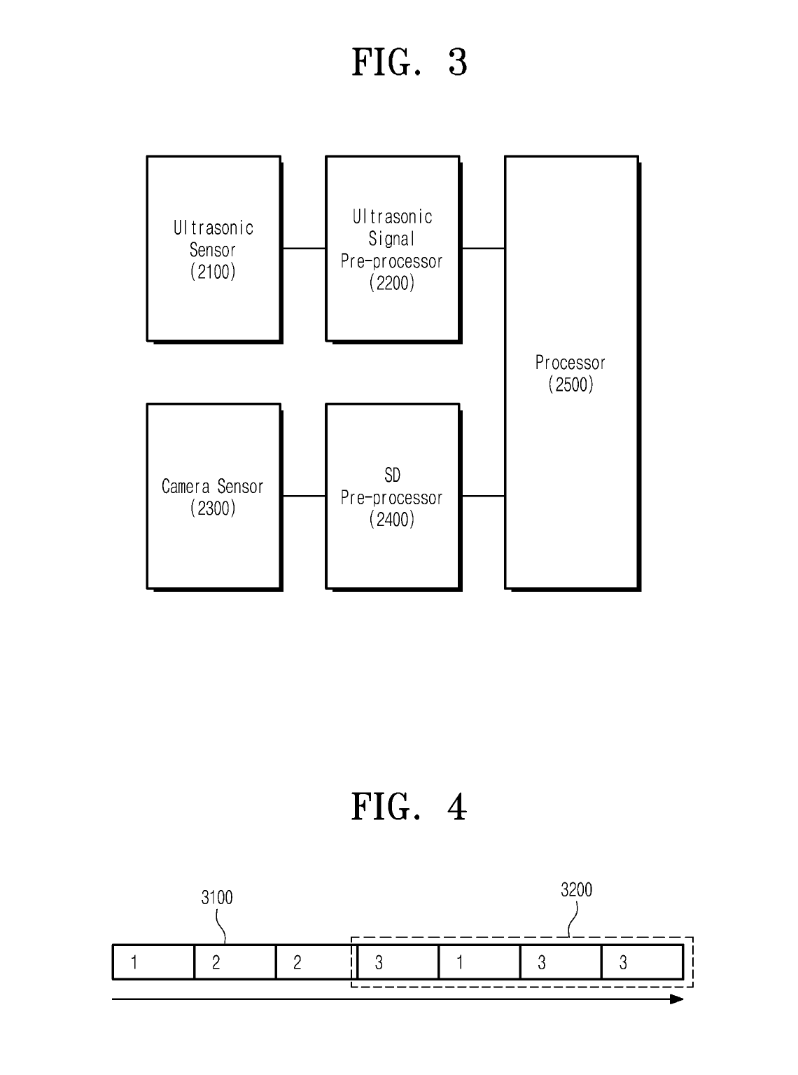

FIG. 3 is a block diagram illustrating a parking control device according to one embodiment of the present disclosure.

Referring to FIG. 3, the parking control device 2000 may include an ultrasonic sensor 2100, an ultrasonic signal pre-processor 2200, a camera sensor 2300, a space detection (SD) pre-processor 2400, and a processor 2500.

The ultrasonic sensor 2100 may be disposed at an appropriate location outside the vehicle to detect objects located at the front, rear, or side of the vehicle.

For example, the ultrasonic sensor 2100 may detect objects at the rear of the vehicle through four ultrasonic sensors disposed at the rear. The ultrasonic sensor 2100 may include a first ultrasonic sensor disposed on the left outer side of the rear of the vehicle, a second ultrasonic sensor disposed on the left side of the center of the rear of the vehicle, a third ultrasonic sensor disposed on the right side of the center of the rear of the vehicle, and a fourth ultrasonic sensor disposed on the right outer side of the rear of the vehicle.

The ultrasonic sensor 2100 may include a transmitter configured to emit ultrasonic waves and a receiver configured to receive the ultrasonic waves returning after being reflected on an object.

The ultrasonic signal pre-processor 2200 may calculate the distance to the object based on the ultrasonic signal received from the ultrasonic sensor 2100, and compute a Time of Flight (ToF) value corresponding to the distance.

The ultrasonic signal pre-processor 2200 may acquire a distance value corresponding to the ultrasonic signal received by the ultrasonic sensor 2100.

The camera sensor 2300 may also be disposed at an appropriate location outside the vehicle to detect objects at the front, rear, or side of the vehicle, and may capture images of the area surrounding the vehicle.

The SD pre-processor 2400 may acquire result values of SD from an image obtained by the camera sensor 2300. Based on the image received from the camera sensor 2300, the SD pre-processor 2400 may extract space detection (SD) feature vectors using deep learning and build SD class data. For example, the classes may include person, vehicle, pillar, curb, and background

The SD pre-processor 2400 may accumulate the SD classes in a time series based on the received SD data.

The SD pre-processor 2400 may accumulate the SD result values in a time series and determine a class with a maximum accumulation as a representative class.

For example, the SD pre-processor 2400 may determine whether the representative class is a class composed of objects having a height unlikely to cause damage to the vehicle (hereinafter, referred to as a first class).

The processor 2500 may compare the SD result values received from the SD pre-processor 2400 and a distance value corresponding to an ultrasonic signal received from the ultrasonic signal pre-processor 2200.

When the representative class is the first class, the processor 2500 may determine whether a target detected by the ultrasonic sensor 2100 and the SD result value included in the first class represent the same target.

When the target detected by the ultrasonic sensor and the space detection result value included in the first class represent the same target, the processor 2500 may delete coordinates of the corresponding SD result value.

When the representative class is a class composed of objects having a height likely to cause damage to the vehicle (hereinafter, referred to as a second class), the processor 2500 may match the SD result value corresponding to the second class with the distance value corresponding to the object detected by the ultrasonic sensor 2100.

When a frequency of matching between the SD result value corresponding to the second class and the distance value corresponding to the detected object is greater than or equal to a threshold, the processor 2500 may determine the SD result value as one of the valid SD result value.

The processor 2500 may determine SD result values having the same distance value as valid SD result values based on the comparison result.

The processor 2500 may cluster the SD result values except for the valid SD result values.

The processor 2500 may then include the clustered SD result values into the valid SD result values. In this case, the clustered SD result values may include an SD result value that is not matched with the distance value corresponding to the ultrasonic signal.

FIG. 4 is a diagram illustrating a method of recognizing SD classes according to one embodiment of the present disclosure.

Referring to FIG. 4, the SD pre-processor 2400 may analyze an image received from the camera 2100 and output SD result values (features). Hereinafter, the SD result values are referred to as SD nodes.

The SD pre-processor 2400 may compensate for the SD nodes based on the vehicle’s motion state (vehicle pose estimation (VPE)). Specifically, the SD pre-processor 2400 may compensate for the positions of the SD nodes based on the VPE.

The SD pre-processor 2400 may accumulate SD classes corresponding to the SD nodes in a buffer 3100 for monitoring. Specifically, the SD pre-processor 2400 may apply a sliding window 3200 and assign the most accumulated class at the most recent time as the representative class among the accumulated data.

For example, when the SD classes are accumulated in the buffer 3100, the data “3,” “3,” “1,” and “3” may be sequentially accumulated over time. Then, the most representative class among the data accumulated by applying the sliding window 3200 may be assigned “3.”

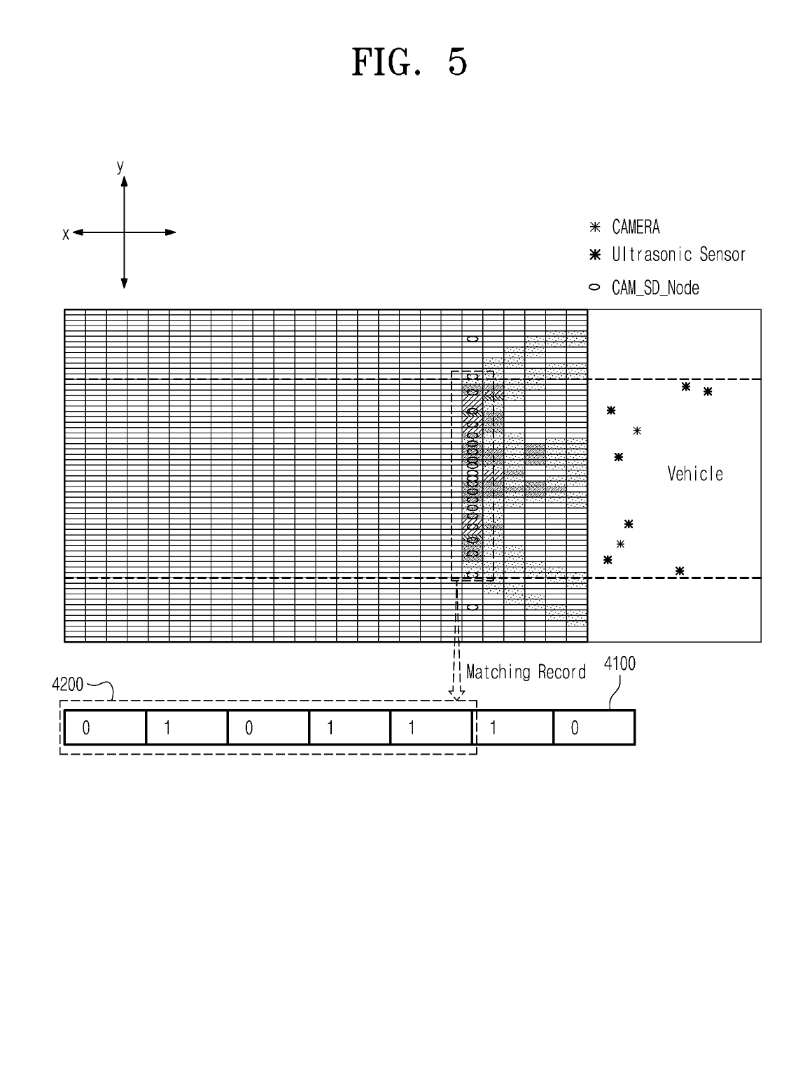

FIG. 5 is a diagram illustrating a method of matching SD nodes and ultrasonic sensor-based distance values according to one embodiment of the present disclosure.

FIG. 5 shows the positions of SD nodes (CAM_SD_Node) measured by the camera sensor (Camera) and arranged in a coordinate space, and SD classes stored in the buffer according to the matching between the SD nodes and the distance values detected by the ultrasonic sensor.

As illustrated in FIG. 5, the processor 2500 may determine the data accumulated in the buffer as SD nodes of the first class, which is an SD class corresponding to “low-height objects,” and SD nodes of the second class, which is an SD class corresponding to “objects that may damage the vehicle.”

The processor 2500 may match the SD nodes from the second class with the distance values from the ultrasonic sensor.

The processor 2500 may record the matching results in a matching buffer 4100 in an accumulating manner.

For example, when an SD node matches a distance value from the ultrasonic sensor, the processor 2500 may store “1” in the matching buffer 4100. When the SD node does not match any distance value from the ultrasonic sensor, the processor 2500 may store “0” as data.

Thereafter, the processor 2500 may apply a sliding window 4200 to check the recent matching frequency. When the frequency of matching of a given SD node is greater than or equal to a threshold, the processor 2500 may determine that the SD node is a valid node.

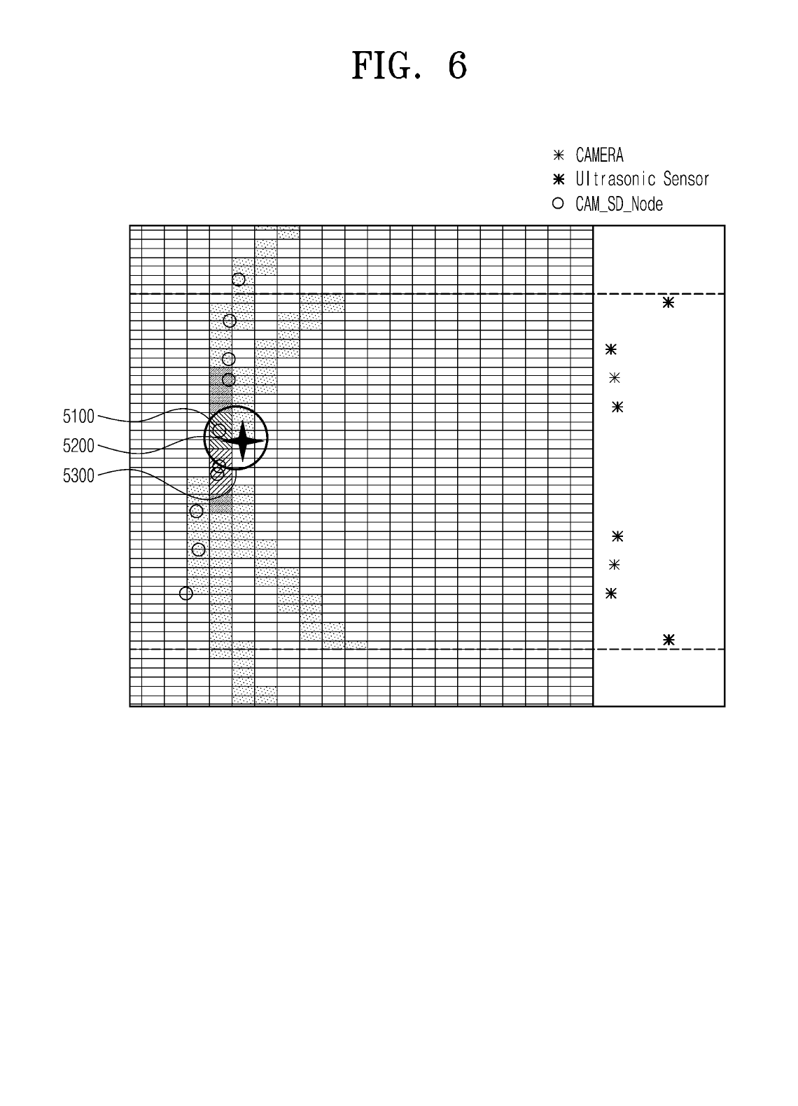

FIG. 6 is a diagram illustrating a method of filtering by matching space detection nodes and ultrasonic sensor-based distance values according to one embodiment of the present disclosure.

Referring to FIG. 6, the processor 2500 may generate a gating zone 5300 around an SD node 5100 in the first class, which represents “low-height objects,” from among the accumulated SD nodes. The gating zone 5300 may be configured based on the detection accuracy of the camera.

When a target 5200 detected only by the ultrasonic sensor is located within the generated gating zone 5300, the processor 2500 may determine that the coordinates are generated according to the first class, and may delete the coordinates of the SD node 5100 of the first class located within the gating zone 5300.

Through the operations described above, the parking control device 2000 may determine whether an object corresponds to the first class, which is an SD class for “low-height objects” and may delete the coordinates of the SD node 5100 through filtering, thereby extending the detection range of the ultrasonic sensor. In other words, the parking control device 2000 may extend the available range of the ultrasonic sensor by filtering distant objects based on the SD classes.

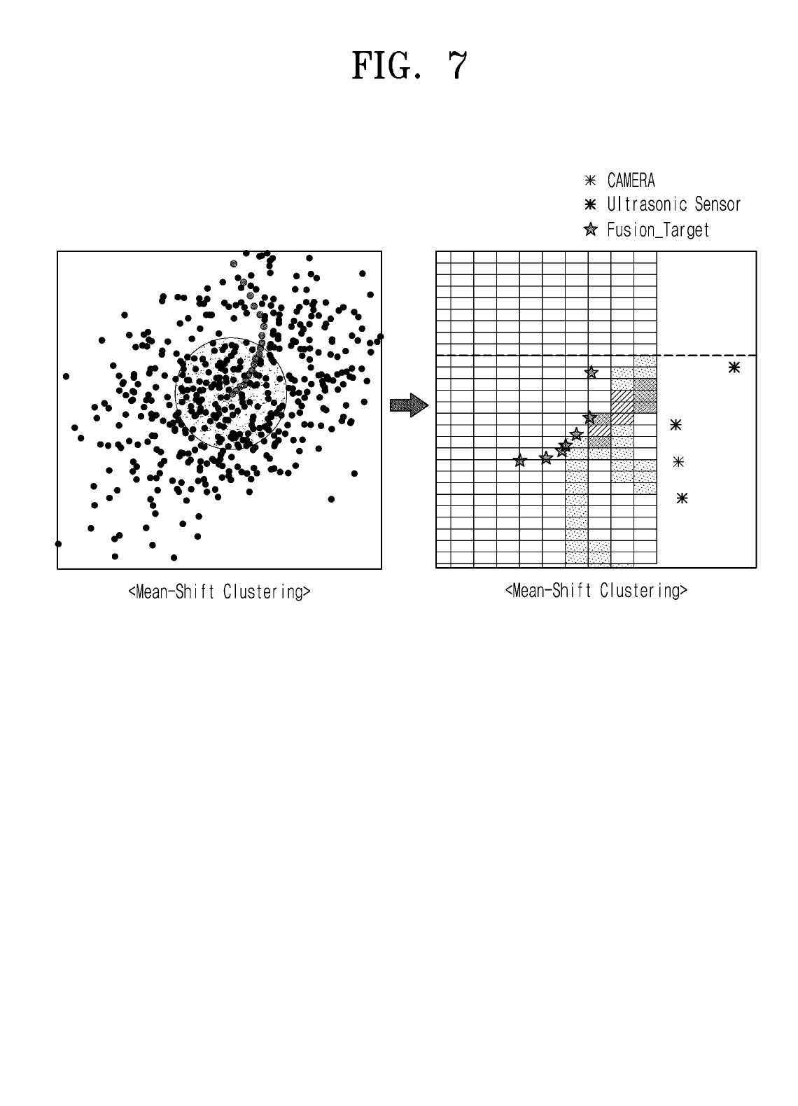

FIG. 7 is a diagram illustrating a process of clustering space detection nodes according to one embodiment of the present disclosure.

Referring to FIG. 7, the processor 2500 may perform clustering by searching for nearby nodes around the valid nodes.

For example, the processor 2500 may cluster the valid nodes using Mean-Shift clustering. In Mean-Shift clustering, a mean shift vector is calculated for each data point, and the data point is shifted using the mean shift vector. When the data points converge through repeated operations of the Mean-Shift algorithm, clusters may be assigned based on the converged data points.

After the clustering, the processor 2500 may determine the valid nodes as fusion targets and map the same onto a sensor fusion map (SF map).

Using the SF map, the processor 2500 may combine surrounding environment data related to the vehicle recognized differently according to the ultrasonic data and camera data, thereby more clearly identifying the spatial relationship between the vehicle and objects outside the vehicle.

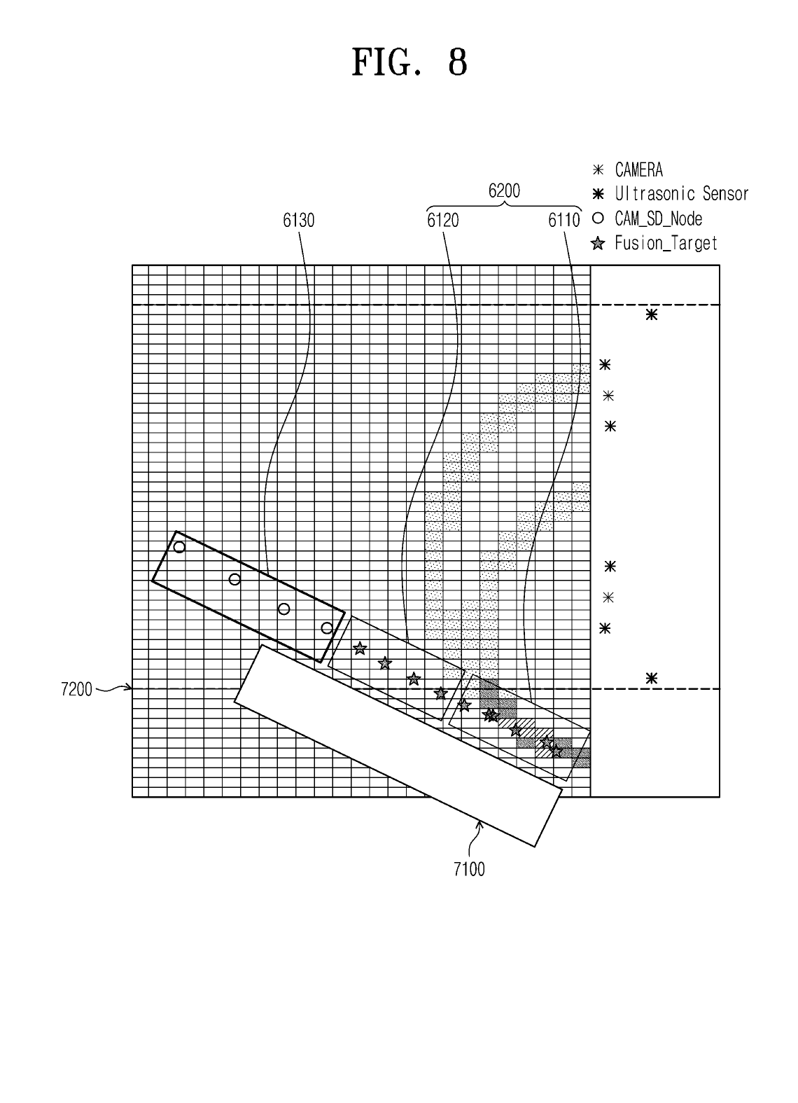

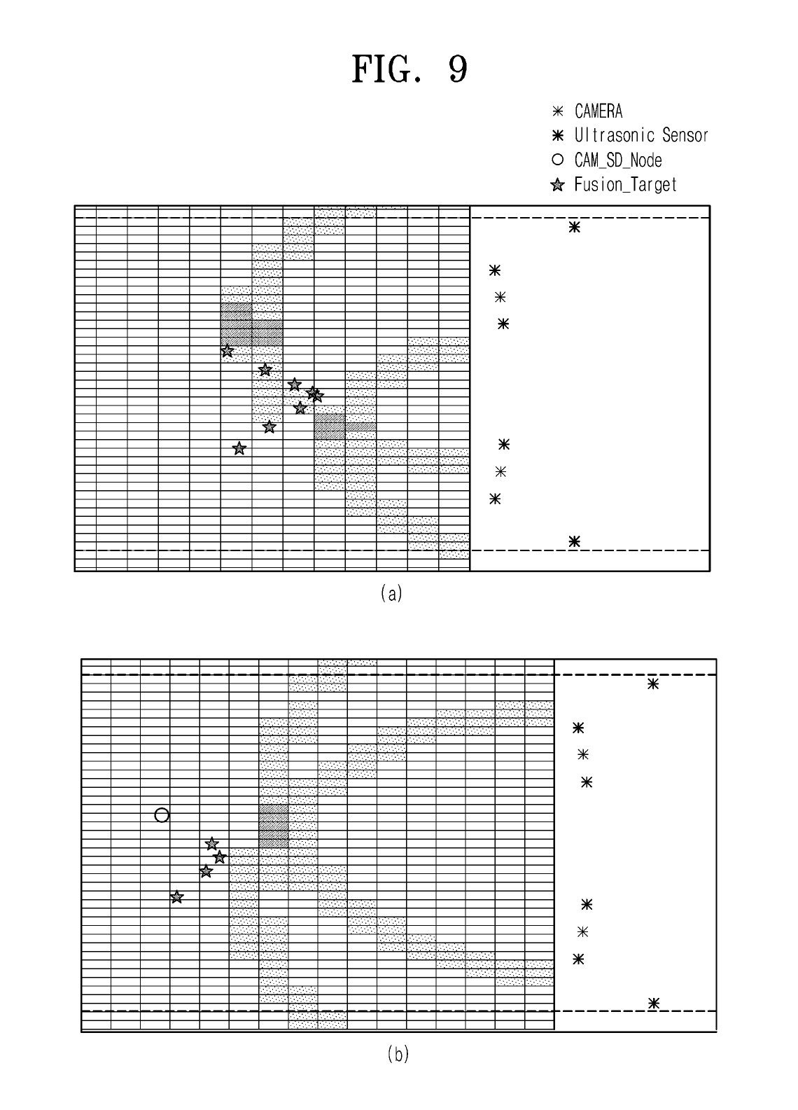

FIGS. 8 and 9 are diagrams illustrating results of sensor fusion based on space detection according to one embodiment of the present disclosure.

FIG. 8 illustrates a case where a vehicle is reversing at 45° with respect to a wall located at the rear of the vehicle.

The parking control device 2000 may detect initial valid nodes 6110 by matching nodes representing objects that may damage the vehicle with ultrasonic signals according to the results of the SD.

Next, the parking control device 2000 may cluster nodes of objects that may damage the vehicle around the initial valid nodes 6110. Then, the parking control device 2000 may identify clustered valid nodes 6120 and non-clustered nodes 6130.

Here, both the clustered nodes 6120 and non-clustered nodes 6130 may be nodes of the SD class indicating objects that may damage the vehicle but are not matched with the ultrasonic signal.

The parking control device may determine the initial valid nodes 6110 and clustered valid nodes 6120 as targets according to sensor fusion.

Therefore, even when the reflective surface of an object 7100 is outside a driving path 7200 of the vehicle, the parking control device may still effectively control the vehicle if the overall shape of the object 7100 lies within the driving path.

FIG. 9 is a diagram illustrating a method of recognizing a rectangular pillar located at the rear of a vehicle according to one embodiment of the present disclosure.

As shown in FIG. 9-(a), the parking control device 2000 may recognize a rectangular pillar located at a close distance from the vehicle as a fusion target through sensor fusion.

As shown in FIG. 9-(b), the parking control device 2000 may filter a distant rectangular object by SD class and recognize the same as a fusion target. In this way, the parking control device 2000 may recognize a distant fusion target.

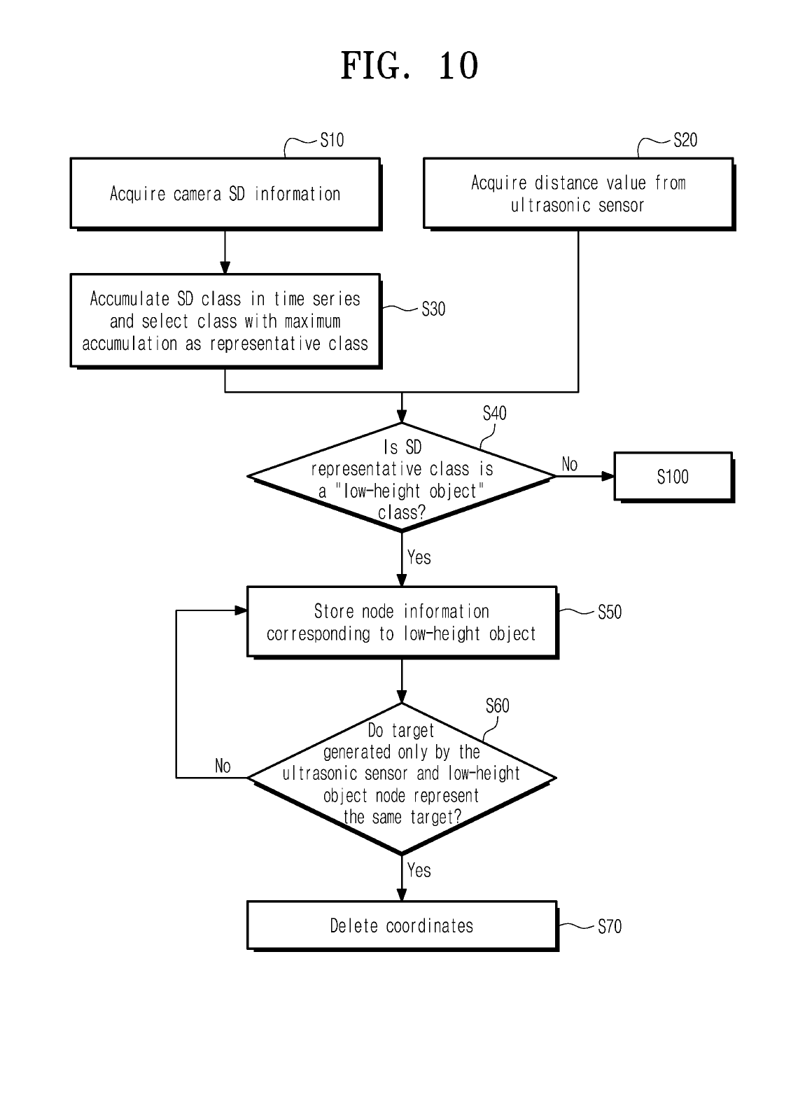

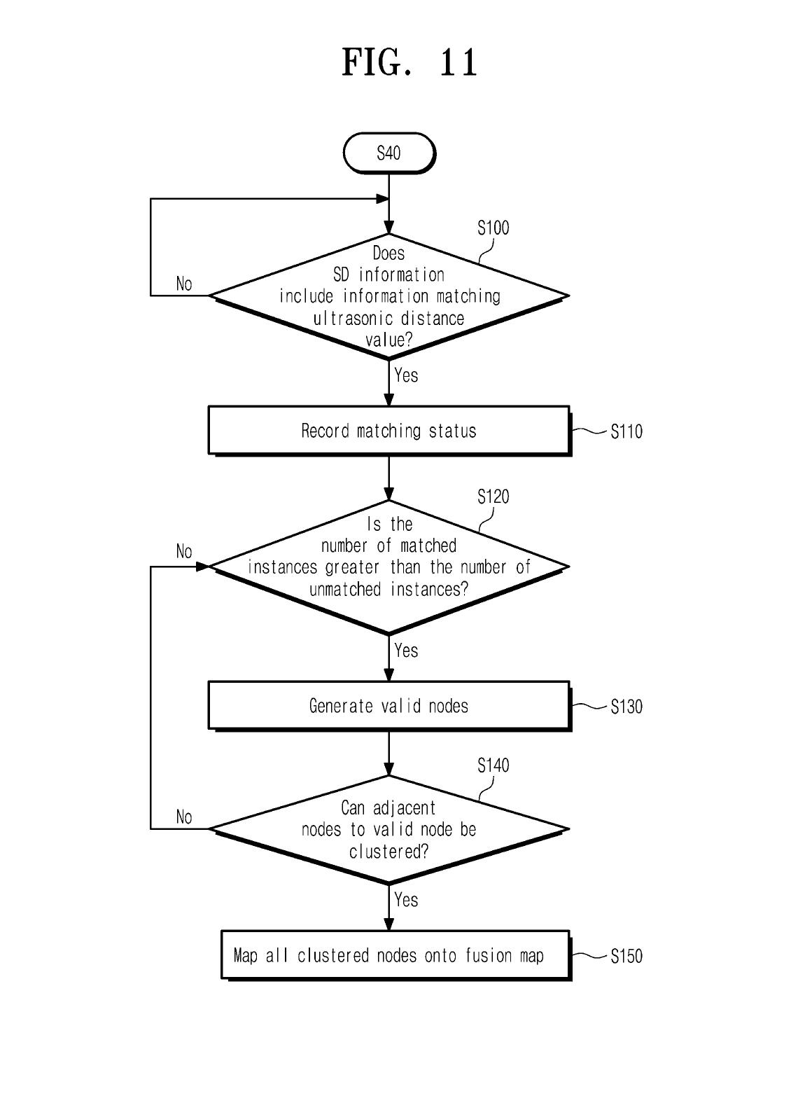

FIGS. 10 and 11 are flowcharts illustrating a sensor fusion method in a parking space according to one embodiment of the present disclosure.

Referring to FIGS. 10 and 11, the parking control device 2000 may acquire SD result values from images obtained by the camera sensor and acquire distance values corresponding to ultrasonic signals received by an ultrasonic sensor (S10 and S20).

After operation S10, the parking control device 2000 may accumulate the SD result values in time series and determine the class with a maximum accumulation as a representative class (S30).

After operation S30, the parking control device 2000 may determine whether the representative class is a “low-height object” class composed of objects that have a height unlikely to cause damage to the vehicle (S40).

When the representative class is a class corresponding to “low-height objects,” the parking control device 2000 may store SD node information related to the class corresponding to “low-height objects” (S50).

Then, the parking control device 2000 may determine whether a target generated only by the ultrasonic sensor and the low-height object node represent the same target (S60).

After operation S60, when the a target generated only by the ultrasonic sensor and the low-height object node represent the same target, the parking control device 2000 may delete the coordinates of the low-height object node corresponding to the same target.

After operation S40, when the representative class is not the class corresponding to the low-height objects,” the parking control device 2000 may determine whether the SD information includes information matching an ultrasonic distance value (S100).

After operation S100, when the SD information includes information matching the ultrasonic distance value, the parking control device 2000 may record the matching status (S110).

After operation S110, the parking control device 2000 may determine whether the number of matched instances is greater than the number of unmatched instances based on the recorded matching results (S120).

After operation S120, if the number of matched instances is greater than the number of unmatched instances, the parking control device 2000 may generate valid nodes for the corresponding SD information (S130). In other words, the parking control device 2000 may compare the SD information with the distance value of the ultrasonic signal and determine SD information having the same distance value as valid nodes.

After operation S130, the parking control device 2000 may determine whether adjacent nodes to the valid node can be clustered (S140).

When the adjacent nodes to the valid node can be clustered, the parking control device 2000 may map all the clustered nodes onto a fusion map. That is, the parking control device 2000 may cluster nodes except for the valid nodes in the SD information, and include the clustered SD result values in the valid SD result values for mapping.

In other words, the technical idea of the present disclosure may be applied to the entirety of an autonomous vehicle or only to some components in the autonomous vehicle. The scope of the present disclosure is to be determined based on the appended claims.

In another aspect of the present disclosure, the above-described proposals or operations of the disclosure may be provided in the form of code that can be implemented, performed, or executed by a “computer” (a broad concept that includes a system on chip (SoC) or microprocessor, etc.), or an application, computer-readable storage medium, or computer program product storing or including the code, which is also within the scope of the present disclosure.

A detailed description of preferred embodiments of the disclosure has been provided above to enable those skilled in the art to implement and practice the disclosure. Although the disclosure has been described above with reference to preferred embodiments of the disclosure, it will be understood by those skilled in the art that various modifications and changes can be made to the disclosure without departing from the scope of the disclosure. For example, those skilled in the art may utilize each of the configurations described in the above-described embodiments by combining them with each other.

Accordingly, the disclosure is not intended to be limited to the embodiments described herein, but rather to provide the broadest possible scope consistent with the principles and novel features disclosed herein.

What is claimed is:

1. A parking control device for a vehicle, the parking control device comprising:
a space detection pre-processor configured to acquire space detection result values from an image acquired by a camera sensor;
an ultrasonic signal pre-processor configured to acquire a distance value corresponding to an ultrasonic signal received by an ultrasonic sensor; and
a processor configured to:
compare the space detection result values with the distance value corresponding to the ultrasonic signal and determine space detection result values having the same distance value among the space detection result values as valid space detection result values;
cluster the space detection result values except for the valid space detection result values; and
include the clustered space detection result values into the valid space detection result values.

2. The parking control device of claim 1, wherein the space detection pre-processor is further configured to:
accumulate the space detection result values in a time series to determine a class with a maximum accumulation of the space detection result values as a representative class; and
determine whether the representative class is a first class composed of objects having a height unlikely to cause damage to the vehicle.

3. The parking control device of claim 2, wherein the processor is further configured to determine whether a target detected by the ultrasonic sensor and the space detection result value included in the first class represent the same target based on the representative class being the first class.

4. The parking control device of claim 3, wherein the processor is further configured to delete coordinates of the space detection result value corresponding to the same target based on the target detected by the ultrasonic sensor and the space detection result value included in the first class representing the same target.

5. The parking control device of claim 2, wherein the clustered space detection result values are space detection result values unmatched to the distance value corresponding to the ultrasonic signal.

6. The parking control device of claim 5, wherein the processor is further configured to match the space detection result value corresponding to the second class with the distance value corresponding to the object detected by the ultrasonic sensor based on the representative class being a second class composed of objects having a height likely to cause damage to the vehicle.

7. The parking control device of claim 6, wherein the processor is further configured to determine the space detection result value as one of the valid space detection result values based on a frequency of matching between the space detection result value corresponding to the second class and the distance value corresponding to the object detected by the ultrasonic sensor being greater than or equal to a threshold.

8. A sensor fusion method for a vehicle, the method comprising:
acquiring space detection result values from an image acquired by a camera sensor;
acquiring a distance value corresponding to an ultrasonic signal received by an ultrasonic sensor;
comparing the space detection result values with the distance value corresponding to the ultrasonic signal and determining space detection result values having the same distance value among the space detection result values as valid space detection result values;
clustering the space detection result values except for the valid space detection result values; and
including the clustered space detection result values into the valid space detection result values.

9. The method of claim 8, wherein the acquiring of the space detection result values comprises:
accumulating the space detection result values in a time series to determine a class with a maximum accumulation of the space detection result values as a representative class; and
determining whether the representative class is a first class composed of objects having a height unlikely to cause damage to the vehicle.

10. The method of claim 9, further comprising:
determining whether a target detected by the ultrasonic sensor and the space detection result value included in the first class represent the same target based on the representative class being the first class; and
deleting coordinates of the space detection result value corresponding to the same target based on the target detected by the ultrasonic sensor and the space detection result value included in the first class representing the same target.

11. A parking control system for a vehicle, the system comprising:
a camera sensor;
a space detection pre-processor configured to acquire space detection result values from an image acquired by the camera sensor;
an ultrasonic sensor;
an ultrasonic signal pre-processor configured to acquire a distance value corresponding to an ultrasonic signal received by the ultrasonic sensor; and
a processor configured to:
compare the space detection result values with the distance value corresponding to the ultrasonic signal and determine space detection result values having the same distance value among the space detection result values as valid space detection result values;
cluster the space detection result values except for the valid space detection result values; and
include the clustered space detection result values into the valid space detection result values.

12. The system of claim 11, wherein the space detection pre-processor is further configured to:
accumulate the space detection result values in a time series to determine a class with a maximum accumulation of the space detection result values as a representative class; and
determine whether the representative class is a first class composed of objects having a height unlikely to cause damage to the vehicle.

13. The system of claim 12, wherein the processor is further configured to determine whether a target detected by the ultrasonic sensor and the space detection result value included in the first class represent the same target based on the representative class being the first class.

14. The system of claim 13, wherein the processor is further configured to delete coordinates of the space detection result value corresponding to the same target based on the target detected by the ultrasonic sensor and the space detection result value included in the first class representing the same target.

15. The system of claim 12, wherein the clustered space detection result values are space detection result values unmatched to the distance value corresponding to the ultrasonic signal.
